(19) United States
(12) Patent Application Publication
(10) Pub. No.: US 2025/0363315 A1
(43) Pub. Date: Nov. 27, 2025

(54) METHOD AND SYSTEM FOR MIXED LANGUAGE TEXT UNDERSTANDING FOR GENERATIVE ARTIFICIAL INTELLIGENCE (GENAI) MODELS

(71) Applicant: Wipro Limited, Bangalore (IN)

(72) Inventors: Arindam CHATTERJEE, Bangalore (IN); Chhavi SHARMA, Noida (IN); Asif EKBAL, Patna (IN)

(73) Assignee: Wipro Limited, Bangalore (IN)

(21) Appl. No.: 18/794,927

(22) Filed: Aug. 5, 2024

(30) Foreign Application Priority Data
May 25, 2024 (IN) 202441040769

(51) Int. Cl. G06F 40/58

(52) U.S. Cl. CPC G06F 40/58

(57) ABSTRACT

This disclosure relates to method and system for mixed language text understanding for Generative Artificial Intelligence (GenAI) models. The method may include receiving a raw parallel corpus of two languages. The method may further include generating a cross-domain codemix parallel corpus and a first set of linguistic features from the raw parallel corpus using statistical and linguistic techniques. The method may further include determining a complexity of each of the plurality of samples of the cross-domain codemix parallel corpus based on a set of complexity parameters. The method may further include sequentially fine-tuning a pre-trained multilingual translation model using each of the plurality of samples in the curriculum learning dataset to obtain a generic pre-trained codemix understanding model.

### TECHNICAL FIELD

This disclosure generally relates to the field of Generative Artificial Intelligence (GenAI), and more particularly to method and system for mixed language text understanding for Generative Artificial Intelligence (GenAI) models.

### BACKGROUND

Codemixing refers to a practice of alternating between two or more languages or linguistic varieties within a single discourse. This phenomenon is prevalent in multilingual communities worldwide and holds significant relevance today, particularly in the field of Natural Language Processing (NLP).

From an NLP perspective, understanding and processing codemixed data present unique challenges due to the complexity of the linguistic structures involved. The relevance of codemixing in NLP extends to various real-world applications. For instance, in social media analysis, where users frequently codemix in their posts, understanding the mixed language content is crucial for sentiment analysis, topic modelling, and user profiling. Moreover, codemixing is also prevalent in customer service interactions, where automated chatbots need to comprehend and respond appropriately to codemixed queries of users.

This linguistic trend poses significant challenges for Artificial Intelligence (AI) systems, particularly in text processing, natural language understanding, and generative tasks, where the presence of multiple languages can disrupt syntactic and semantic consistency of the data. Conventional AI and Natural Language Processing (NLP) models are typically designed to operate on monolingual data. When confronted with codemixed text, the conventional models experience degraded performance due to their inability to contextually interpret and process linguistic nuances of mixed-language inputs. This results in poor understanding, inaccurate translations, and subpar generation of text, thus impeding the effectiveness of AI applications in multilingual environments.

Additionally, the multimodal applications of AI, which involve the integration of text with other forms of data (such as images, audio, and video), face compounded complexities when dealing with codemixed content. The lack of coherence between text and other modalities in codemixed scenarios can lead to ineffective training of multimodal models, resulting in errors or biases in AI-generated content. Consequently, a deficiency persists wherein existing systems lack the capability to proficiently translate codemixed language into a singular language or vice versa.

Previous approaches for translation of codemixed text aimed at comprehending and translating mixed-language text using rule-based systems. However, these systems are inadequate in tackling the unpredictable nature of code-switching and codemixing.

With the emergence of statistical machine translation (SMT), researchers delved into data-driven methodologies. Nevertheless, the scarcity of parallel corpora (i.e., text data including translations of one or more languages) for codemixed languages persisted as a challenge. The advent of Neural Machine Translation (NMT) marked a pivotal shift, offering novel pathways for addressing the intricacies of codemixed language translation. Leveraging the adaptability of neural networks has exhibited potential in capturing the subtleties of mixed language syntax.

A small but significant body of work exists in the direction of codemix language understanding, but they suffer from major bottlenecks such as scarcity of data and inefficient strategy. Due to the lack of sufficient codemixed data available online, deep learning models that are data-hungry cannot be trained efficiently. Further, the models that are available are trained on insufficient data and are, therefore, not highly accurate.

FIG. 1 (PRIOR ART) illustrates an exemplary conventional method 100 for fine-tuning pre-trained multilingual models using a small corpus of codemix data. The conventional method 100 uses statistical models to fine-tune a small corpus of customer data 102 (i.e., codemix data (domain/client data)) on an existing pre-trained multilingual translation model 104. Upon fine-tuning, a domain specific codemix understanding model 106 is obtained. Although the conventional method 100 produced better results, the conventional method 100 did not scale to perform well enough for real-life applications. This is primarily because the pre-trained multilingual translation model 104 fails to capture the semantics of two languages used in the same discourse.

Unlike traditional bilingual corpora, codemixed data necessitates an understanding of the intricate grammatical structures and cultural contexts inherent in language blending. Existing machine translation endeavors for codemixed languages have predominantly faced limitations stemming from the scarcity of robust datasets and models capable of capturing the nuanced semantic and syntactic interplay inherent in such linguistic contexts.

To summarize, the absence of automated systems capable of comprehending and converting codemixed content into a monolingual format has created a substantial void within the industry. This void is particularly conspicuous in multilingual countries, in sectors such as AI-based customer service, content moderation, dataset standardization, multimodal model integration, and related applications. Consequently, there exists an imperative and ongoing necessity to address this issue, thereby this invention aims at rectifying a substantial gap within the realms of AI and Generative AI industries.

### SUMMARY

In one embodiment, a method for mixed language text understanding for Generative Artificial Intelligence (GenAI) models is disclosed. The method may include receiving a raw parallel corpus of two languages. The raw parallel corpus may include a plurality of samples of cross-domain parallel text data in the two languages. The method may further include generating a cross-domain codemix parallel corpus and a first set of linguistic features from the raw parallel corpus using statistical and linguistic techniques. The method may further include determining a complexity of each of the plurality of samples of the cross-domain codemix parallel corpus based on a set of complexity parameters. The method may further include preparing a curriculum learning dataset from the cross-domain codemix parallel corpus based on the complexity of each of the plurality of samples. The method may further include sequentially fine-tuning a pre-trained multilingual translation model using each of the plurality of samples in the curriculum learning dataset to obtain a generic pre-trained codemix understanding model.

In another embodiment, a computing device for mixed language text understanding for Generative Artificial Intelligence (GenAI) models is disclosed. In one example, the computing device may include a processor and a computer-readable medium communicatively coupled to the processor. The computer-readable medium may store processor-executable instructions, which, on execution, may cause the processor to receive a raw parallel corpus of two languages. The raw parallel corpus may include a plurality of samples of cross-domain parallel text data in the two languages. The processor-executable instructions, on execution, may further cause the processor to generate a cross-domain codemix parallel corpus and a first set of linguistic features from the raw parallel corpus using statistical and linguistic techniques. The processor-executable instructions, on execution, may further cause the processor to determine a complexity of each of the plurality of samples of the cross-domain codemix parallel corpus based on a set of complexity parameters. The processor-executable instructions, on execution, may further cause the processor to prepare a curriculum learning dataset from the cross-domain codemix parallel corpus based on the complexity of each of the plurality of samples. Further, the processor-executable instructions, on execution, may cause the processor to sequentially fine-tune a pre-trained multilingual translation model using each of the plurality of samples in the curriculum learning dataset to obtain a generic pre-trained codemix understanding model.

In another embodiment, a non-transitory computer-readable medium storing computer-executable instructions for mixed language text understanding for Generative Artificial Intelligence (GenAI) models is disclosed. In one example, the stored instructions, when executed by a processor, may cause the processor to receive a raw parallel corpus of two languages. The raw parallel corpus may include a plurality of samples of cross-domain parallel text data in the two languages. The operations may further include generating a cross-domain codemix parallel corpus and a first set of linguistic features from the raw parallel corpus using statistical and linguistic techniques. The operations may further include determining a complexity of each of the plurality of samples of the cross-domain codemix parallel corpus based on a set of complexity parameters. The operations may further include prepare a curriculum learning dataset from the cross-domain codemix parallel corpus based on the complexity of each of the plurality of samples. The operations may further include sequentially fine-tuning a pre-trained multilingual translation model using each of the plurality of samples in the curriculum learning dataset to obtain a generic pre-trained codemix understanding model

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 (PRIOR ART) illustrates a flowchart of an exemplary conventional method for fine-tuning pre-trained multilingual models, in accordance with some embodiments of the present disclosure.

FIG. 2 is a block diagram of an exemplary system for mixed language text understanding for Generative Artificial Intelligence (GenAI) models, in accordance with some embodiments of the present disclosure.

FIG. 3 illustrates a functional block diagram of an exemplary system for mixed language text understanding for generic GenAI models, in accordance with some embodiments of the present disclosure.

FIG. 4 illustrates a flowchart of an exemplary process for mixed language text understanding for generic GenAI models, in accordance with some embodiments of the present disclosure.

FIG. 5 illustrates a flowchart of a detailed exemplary process for mixed language text understanding for generic GenAI models, in accordance with some embodiments of the present disclosure.

FIG. 6 illustrates a functional block diagram of an exemplary system for preparing cross-domain codemix parallel corpus, in accordance with some embodiments of the present disclosure.

FIG. 7 illustrates pre-processing of cross-domain codemix parallel corpus, in accordance with some embodiments of the present disclosure.

FIG. 8 illustrates data format of original cross-domain parallel corpus including codemix data and corresponding translations to multiple languages, in accordance with some embodiments of the present disclosure.

FIG. 9 illustrates data format of pre-processed cross-domain parallel corpus including codemix data and corresponding translations to a first language, in accordance with some embodiments of the present disclosure.

FIG. 10 illustrates data format of pre-processed cross-domain parallel corpus including codemix data and corresponding translations to a second language, in accordance with some embodiments of the present disclosure.

FIG. 11 illustrates a flow diagram of an exemplary process for mixed language text understanding for pre-trained multilingual translation models, in accordance with some embodiments of the present disclosure.

FIG. 12 illustrates a functional block diagram of an exemplary system for mixed language text understanding for domain specific GenAI models, in accordance with some embodiments of the present disclosure.

FIG. 13 illustrates a flowchart of an exemplary process for mixed language text understanding for domain specific GenAI models, in accordance with some embodiments of the present disclosure.

FIG. 14 illustrates a flow diagram of a detailed exemplary process for mixed language text understanding for domain specific GenAI models, in accordance with some embodiments of the present disclosure.

FIG. 15 illustrates a functional block diagram of an exemplary system for preparing cross-domain parallel corpus and domain specific parallel corpus of codemix data, in accordance with some embodiments of the present disclosure.

FIG. 16 illustrates a flow diagram of an exemplary process for mixed language text understanding for generic pre-trained codemix understanding models, in accordance with some embodiments of the present disclosure.

FIG. 17 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

Referring now to FIG. 2, a block diagram of an exemplary system 200 for mixed language text understanding for generative Artificial Intelligence (GenAI) models is illustrated, in accordance with some embodiments of the present disclosure. The system 200 may include a computing device 202 (for example, server, desktop, laptop, notebook, netbook, tablet, smartphone, mobile phone, or any other computing device), in accordance with some embodiments of the present disclosure. The computing device 202 may fine-tune GenAI models. It should be noted that, in some embodiments, the computing device 202 may prepare a parallel corpus of codemix data to fine-tune the GenAI models.

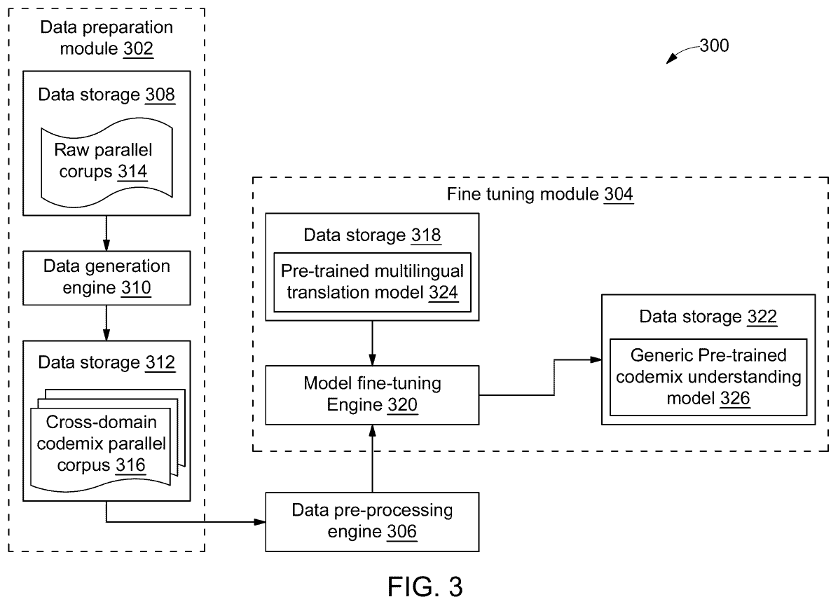

As will be described in greater detail in conjunction with FIGS. 3-16, the computing device 202 may receive codemix data corresponding to each of at least one parallel corpus. The at least one parallel corpus may include at least one of a cross-domain parallel corpus or a domain specific parallel corpus. Further, the computing device 202 may preprocess the at least one parallel corpus using a preprocessing technique to obtain a corresponding at least one pre-processed parallel corpus. Further, the computing device 202 may prepare a curriculum learning dataset from the at least one pre-processed parallel corpus based on a difficulty ranking mechanism. Further, the computing device 202 may fine-tune a pre-trained multilingual GenAI model using the curriculum learning dataset.

In some embodiments, the computing device 202 may include one or more hardware processors (hereinafter referred as processors) 204 and a memory 206. Further, the memory 206 may store processor-executable instructions that, when executed by the one or more processors 204, cause the one or more processors 204 to perform mixed language text understanding for GenAI models, in accordance with aspects of the present disclosure. The memory 206 may also store various data (for example, raw parallel corpus, cross-domain codemix parallel corpus, domain specific text data, domain specific codemix parallel corpus, curriculum learning dataset, GenAI model data, and the like) that may be captured, processed, and/or required by the system 200. The memory 206 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

The system 200 may further include a display 208. The system 200 may interact with a user via a user interface 210 accessible via the display 208. The system 200 may also include one or more external devices 212. In some embodiments, the computing device 202 may interact with the one or more external devices 212 over a communication network 214 for sending or receiving various data. The external devices 212 may include, but may not be limited to, a remote server, a digital device, or another computing system.

Referring now to FIG. 3, a functional block diagram of an exemplary system 300 for mixed language text understanding for generic GenAI models is illustrated, in accordance with some embodiments of the present disclosure. FIG. 3 is explained in conjunction with FIG. 2. The system 300 may include, within the memory 206, a data preparation module 302, a fine-tuning module 304, and a data pre-processing engine 306. The data preparation module 302 may include a data storage 308, a data generation engine 310, and a data storage 312. The data storage 308 may store a raw parallel corpus 314. The raw parallel corpus 314 may include parallel text in two languages L₁ and L₂ (for example, English and French, English and Spanish, Hindi and English, Spanish and Portuguese, etc.).

The data generation engine 310 may receive the raw parallel corpus 314 from the data storage 308. Further, the data generation engine 310 may generate a cross-domain codemix parallel corpus 316 from the raw parallel corpus 314. The cross-domain codemix parallel corpus 316 may be a fusion of languages L₁ and L₂. Further, the data generation engine 310 may store the cross-domain codemix parallel corpus 316 in the data storage 312.

Further, the data pre-processing engine 306 may receive the cross-domain codemix parallel corpus 316 from the data storage 312. The data pre-processing engine 306 may transform original format of the cross-domain codemix parallel corpus 316 into a pre-processed format.

The fine-tuning module 304 may include a data storage 318, a model fine-tuning engine 320, and a data storage 322. The data storage 318 may include a pre-trained multilingual translation model 324. The pre-trained multilingual translation model 324 may be a pre-trained GenAI model, such as, but not limited to, Generative Pre-trained Transformers (GPT), Gemini, Large Language Model Meta AI (LLaMA), and the like. The model fine-tuning engine 320 may receive the cross-domain codemix parallel corpus 316 in the pre-processed format from the data pre-processing engine 306. Additionally, the model fine-tuning engine 320 may retrieve the pre-trained multilingual translation model 324 from the data storage 318.

The model fine-tuning engine 320 may determine a complexity of the plurality of samples of the cross-domain codemix parallel corpus based on a set of complexity parameters. The model fine-tuning engine 320 calculates a complexity metric of each of a set of training data (obtained from the cross-domain codemix parallel corpus 316) based on a curriculum learning framework. Further, the model fine-tuning engine 320 ranks each of the set of training data based on the complexity metric. The curriculum learning framework enables the pre-trained multilingual translation model 324 to gradually learn from simpler to more complex data in the set of training data, thereby enhancing ability of the pre-trained multilingual translation model 324 to learn intricacies and nuances of various degrees and types of codemixing. The model fine-tuning engine 320 may fine-tune the pre-trained multilingual translation model 324 to obtain a generic pre-trained codemix understanding model 326.

The generic pre-trained codemix understanding model 326 is cross-domain. The generic pre-trained codemix understanding model 326 is trained on a significantly large corpus spanning several domains (i.e., the cross-domain codemix parallel corpus 316). The generic pre-trained codemix understanding model 326 is designed to provide a robust foundation for understanding and translating codemixed languages. Further, the model fine-tuning engine 320 may store the generic pre-trained codemix understanding model 326 in the data storage 322.

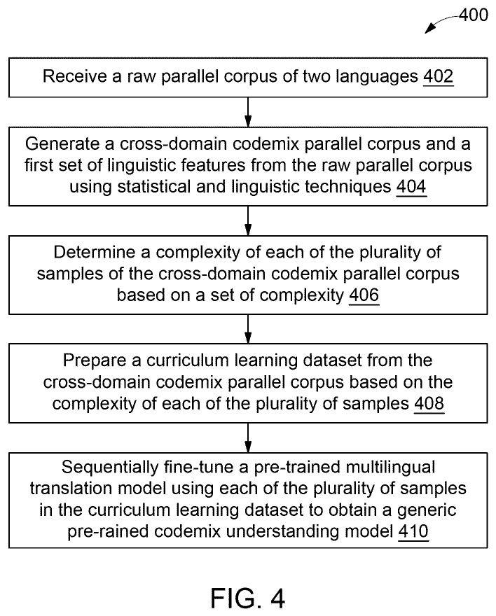

Referring now to FIG. 4, an exemplary process 400 for mixed language text understanding for GenAI models is depicted via a flowchart, in accordance with some embodiments of the present disclosure. FIG. 4 is explained in conjunction with FIGS. 2 and 3. The process 400 may be implemented by the computing device 202 of the system 200. The process 400 may include receiving, by the data generation engine 310, a raw parallel corpus of two languages (for example, the raw parallel corpus 314). The raw parallel corpus may include a plurality of samples of cross-domain parallel text data in the two languages, at step 402.

Further, the process 400 may include generating, by the data generation engine 310, a cross-domain codemix parallel corpus (such as the cross-domain codemix parallel corpus 316) and a first set of linguistic features from the raw parallel corpus using statistical and linguistic techniques, at step 404.

In some embodiments, the process 400 may include preprocessing the cross-domain codemix parallel corpus by the data pre-processing engine 306 to obtain a pre-processed cross-domain codemix parallel corpus for each language of the two languages. The pre-processed cross-domain codemix parallel corpus may include cross-domain codemix text data, corresponding cross-domain text data in the language, the first set of linguistic features, and translation data of the language corresponding to the cross-domain text data. It may be noted that the first set of linguistic features may include values for Part-of-Speech for each word, word-level language identification, switching point, mixing index, and matrix language.

Further, the process 400 may include determining, by the model fine-tuning engine 320, a complexity of each of the plurality of samples of the cross-domain codemix parallel corpus based on a set of complexity parameters, at step 406. By way of an example, the set of complexity parameters may include language switching points, language mix index, lexical rarity, or the like.

Further, the process 400 may include preparing, by the model fine-tuning engine 320, a curriculum learning dataset from the cross-domain codemix parallel corpus based on the complexity of each of the plurality of samples, at step 408. Further, the step 408 of the process 400 may include arranging the plurality of samples of the cross-domain codemix parallel corpus in an order based on the complexity.

Further, the process 400 may include sequentially fine-tuning, by the model fine tuning engine 320, a pre-trained multilingual translation model (for example, the pre-trained multilingual translation model 324) using each of the plurality of samples in the curriculum learning dataset to obtain a generic pre-trained codemix understanding model (for example, the generic pre-trained codemix understanding model 326), at step 410. It may be noted that the step 410 of the process 400 may include individually fine-tuning the pre-trained multilingual translation model using each sample of the curriculum learning dataset in an increasing order of complexity.

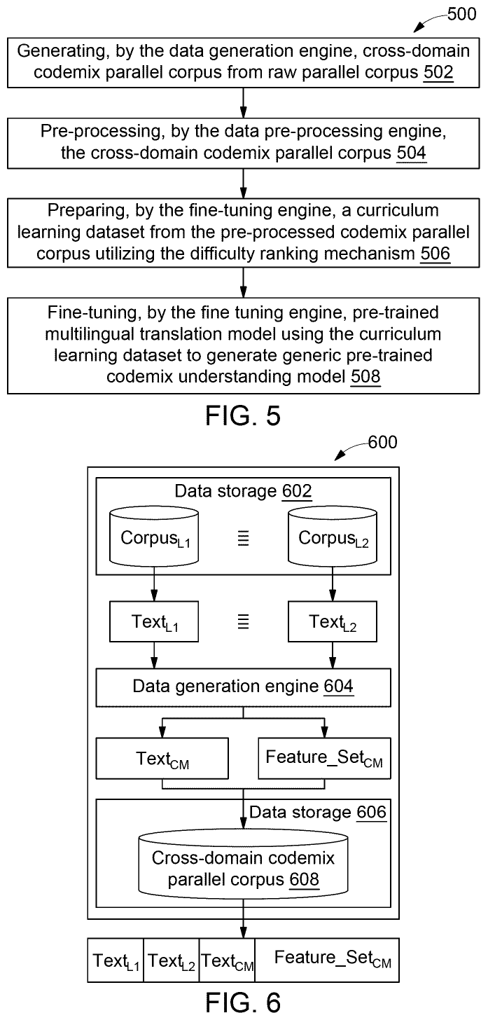

Referring now to FIG. 5, a detailed exemplary process 500 for mixed language text understanding for generic GenAI models is depicted via a flow chart, in accordance with some embodiments of the present disclosure. FIG. 5 is explained in conjunction with FIGS. 2, 3, 4, and 5. The process 500 may include generating, by the data generation engine 310, the cross-domain codemix parallel corpus 316 (i.e., a generic codemix parallel corpus) from the raw parallel corpus 314, at step 502. This is further explained in greater detail in conjunction with FIG. 6.

Referring now to FIG. 6, a functional block diagram of an exemplary system 600 for preparing cross-domain codemix parallel corpus is illustrated, in accordance with some embodiments of the present disclosure. FIG. 6 is explained in conjunction with FIGS. 2, 3, 4, and 5. The system 600 may include a data storage 602 (analogous to the data storage 308), a data generation engine 604 (analogous to the data generation engine 310), and a data storage 606 (analogous to the data storage 312). In some embodiments, codemix data may be desired for languages L₁ and L₂. The data storage 602 may store a raw parallel corpus (such as the raw parallel corpus 314). The raw parallel corpus may include a Corpus_{L1} (i.e., a raw corpus including parallel text data Text_{L1} corresponding to language L₁) and a Corpus_{L2} (i.e., a raw corpus including parallel text data Text_{L2} corresponding to language L₂).

Further, the data storage 602 provides the Text_{L1} and the Text_{L2} to the data generation engine 604 to produce parallel text (Text_{CM}) in codemix (i.e., a fusion of languages L₁ and L₂) and a set of linguistic features (Feature_Set_{CM}) corresponding to the Text_{CM}.

The data generation engine 604 employs a mix state-of-the-art statistical and linguistic techniques to generate natural and semantically consistent codemix text (Text_{CM}) and the set of linguistic features (Feature_Set_{CM}) from parallel texts Text_{L1} and Text_{L2}. Further, the data generation engine 604 stores the generated codemix text (Text_{CM}) and the set of linguistic features (Feature_Set_{CM}) in the data storage 606 in form of a cross-domain codemix parallel corpus 608 (analogous to the cross-domain codemix parallel corpus 316). The cross-domain codemix parallel corpus 608 includes the codemix text (Text_{CM}) supplemented by the defined set of linguistic features (Feature_Set_{CM}). In other words, the cross-domain codemix parallel corpus 608 includes multiple sets of Text_{L1}, Text_{L2}, Text_{CM}, and Feature_Set_{CM} and is stored in the data storage 606.

The set of linguistic features (Feature_Set_{CM}) may include one or more linguistic features such as, but not limited to, Part-of-Speech (POS_{CM}), Word-level Language Identification (WLI_{CM}), Switching Point (SP_{CM}), Mixing Index (MI_{CM}), Matrix Language of the codemix text (MTL_{CM}), and the like. In an embodiment, the set of linguistic features (Feature_Set_{CM}) may be denoted as follows:

$$Feature\_Set \_CM {=}_{=} < {POS}_{CM} , {WLI}_{CM} , {SP}_{CM} , {MI}_{CM} , {MTL}_{CM} >$$

It may be noted that POS_{CM} may include the Part-of-Speech for each word in the codemix text (Text_{CM}). WLI_{CM} may capture language for each word in the codemix text (Text_{CM}). SP_{CM} is a junction in the codemix text (Text_{CM}) where a language switches. Such junctions are marked specifically in the codemix text (Text_{CM}), as this is a key feature that captures the nuances of language switch in a codemix context. MI_{CM} denotes a degree of mixing in the codemix text (Text_{CM}). The higher the MI_{CM} value, the more complex the codemix text (Text_{CM}) is to understand and process. MTL_{CM} denoted the matrix language of the codemix text (Text_{CM}). The matrix language in codemix is a base language of the codemix text (Text_{CM}) in which another language is embedded.

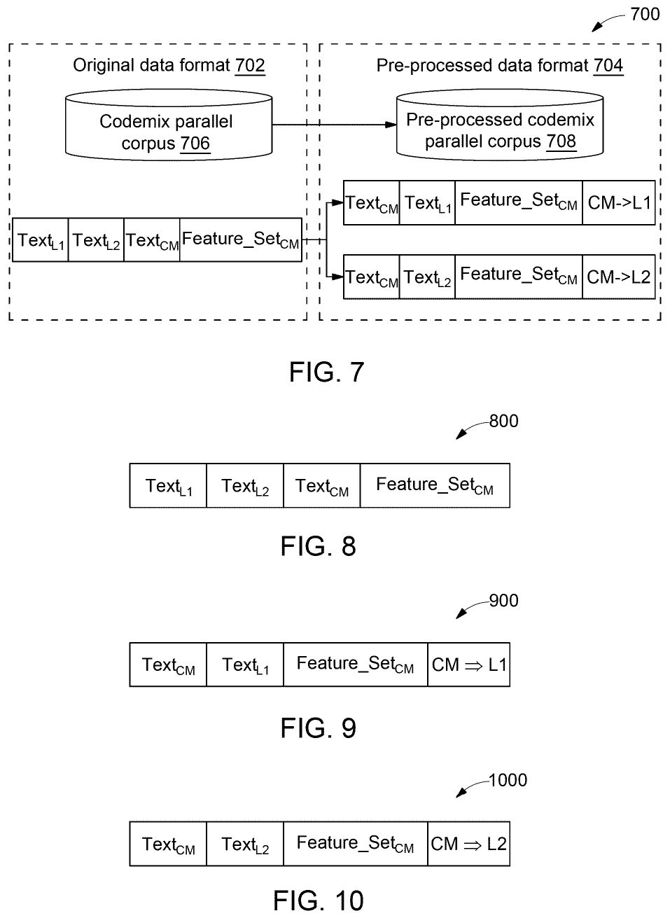

Referring back to FIG. 5, the process 500 may include pre-processing, by the data pre-processing engine 306, the cross-domain codemix parallel corpus 316, at step 504. This is explained in greater detail in conjunction with FIGS. 7, 8, 9, and 10.

Referring now to FIG. 7, pre-processing of cross-domain codemix parallel corpus is illustrated, in accordance with some embodiments of the present disclosure. FIG. 7 is explained in conjunction with FIGS. 2, 3, 4, 5, and 6. The pre-processing may include transformation of the cross-domain parallel corpus from an original data format 702 to a pre-processed data format 704. The data pre-processing engine 306 may receive a codemix parallel corpus 706 (analogous to the cross-domain codemix parallel corpus 608) from a data storage (such as the data storage 606). In the original data format 702, the codemix parallel corpus 706 may include multiple sets of parallel texts in languages L₁ and L₂, (i.e., Text_{L1} and Text_{L2}, respectively), codemix text (Text_{CM}), and a corresponding set of linguistic features (Feature_Set_{CM}), as generated by the data generation engine 604.

Further, the data pre-processing engine 306 may transform the codemix parallel corpus 706 from the original data format 702 into the pre-processed data format 704 to obtain a pre-processed codemix parallel corpus 708. In the pre-processed data format 704, each of the multiple sets of parallel texts in languages L₁ and L₂ is split into two separate sets of parallel texts. Each of the two separate sets of parallel texts includes the codemix text (Text_{CM}), a parallel text translation of the codemix text to the single language (one of Text_{L1} or Text_{L2}), a corresponding set of linguistic features (Feature_Set_{CM}), and a marker representing translation of the codemix text data to the language. Thus, a first set of the pre-processed codemix parallel corpus 708 may include multiple sets of the codemix text (Text_{CM}), parallel text translation of the codemix text data to the language L₁ (Text_{L1}), the corresponding set of linguistic features (Feature_Set_{CM}), and a marker representing translation of the codemix text data to the language L₁ (CM->L₁). A second set of the pre-processed codemix parallel corpus 708 may include multiple sets of the codemix text (Text_{CM}), parallel text translation of the codemix text data to the language L₁ (Text_{L1}), the corresponding set of linguistic features (Feature_Set_{CM}), and a marker representing translation of the codemix text data to the language L₁ (CM->L₁). This is explained in greater detail in conjunction with FIGS. 8, 9, and 10.

Referring now to FIG. 8, data format 800 of original cross-domain parallel corpus including codemix data and corresponding translations to multiple languages is illustrated, in accordance with some embodiments of the present disclosure. FIG. 8 is explained in conjunction with FIGS. 2, 3, 4, 5, 6, and 7. The data format 800, as generated by the data generation engine 604, may include 4 columns—parallel text data in language L₁ (Text_{L1}), parallel text data in language L₂ (Text_{L2}), codemix text data (Text_{CM}), and a corresponding set of linguistic features (Feature_Set_{CM}).

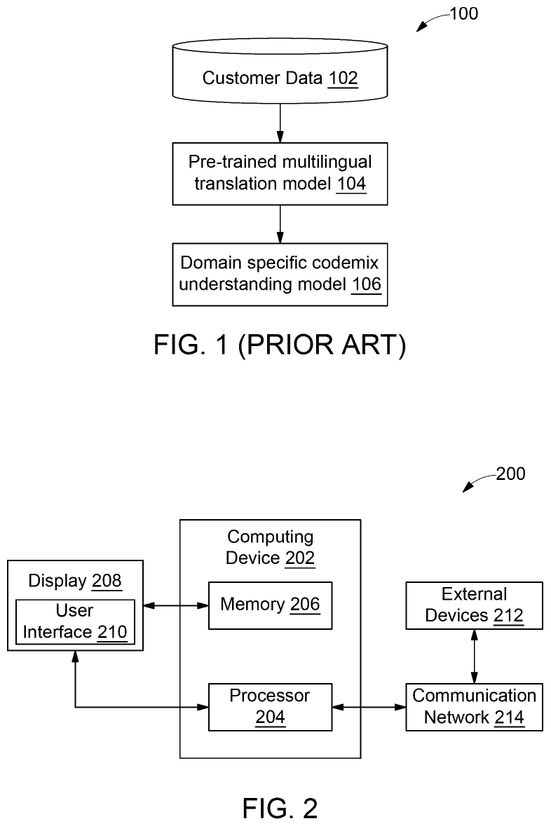

Referring now to FIG. 9, data format 900 of pre-processed cross-domain parallel corpus including codemix data and corresponding translations to a first language (i.e., L₁) is illustrated, in accordance with some embodiments of the present disclosure. FIG. 9 is explained in conjunction with FIGS. 1, 2, 3, 4, 5, 6, 7, and 8.

The data format 900, as generated by the data pre-processing engine 306, may include 4 columns—codemix text data (Text_{CM}), parallel text translation of the codemix text data to the language L₁ (Text_{L1}), a corresponding set of linguistic features (Feature_Set_{CM}), and a marker representing translation of the codemix text data to the language L₁ (CM->L₁).

Referring now to FIG. 10, data format 1000 of pre-processed cross-domain parallel corpus including codemix data and corresponding translations to a second language is illustrated, in accordance with some embodiments of the present disclosure. FIG. 10 is explained in conjunction with FIGS. 2, 3, 4, 5, 6, 7, 8, and 9. The data format 1000, as generated by the data pre-processing engine 306, may include 4 columns-codemix text data (Text_{CM}), parallel text translation of the codemix text data to the language L₂ (Text_{L2}), a corresponding set of linguistic features (Feature_Set_{CM}), and a marker representing translation of the codemix text data to the language L₂ (CM->L₂).

Referring back to FIG. 5, the data pre-processing engine 306 may send the pre-processed cross-domain codemix parallel corpus 708 to the model fine-tuning engine 320. Further, the process 500 may include preparing, by the model fine-tuning engine 320, a curriculum learning dataset from the pre-processed codemix parallel corpus using the difficulty ranking mechanism, at step 506.

In the context of deep learning, curriculum learning pertains to a methodological approach for training neural networks that mirrors human learning patterns, characterized by a gradual increase in task complexity.

Curriculum learning involves structuring the pre-processed codemix parallel corpus (training data) into a curriculum or a sequence of tasks. Each successive task presents increasing levels of difficulty. A pivotal component of curriculum learning involves the utilization of a complexity metric, which evaluates the difficulty level associated with each training sample. The complexity metric facilitates the arrangement of training samples in the curriculum training dataset according to a perceived difficulty of each of the training samples, enabling the pre-trained multilingual translation model to initially learn from simpler examples and progressively address more intricate ones. Thus, curriculum learning endeavors to enhance the efficiency and efficacy of the learning process, ultimately leading to improved generalization and performance of the pre-trained multilingual translation model.

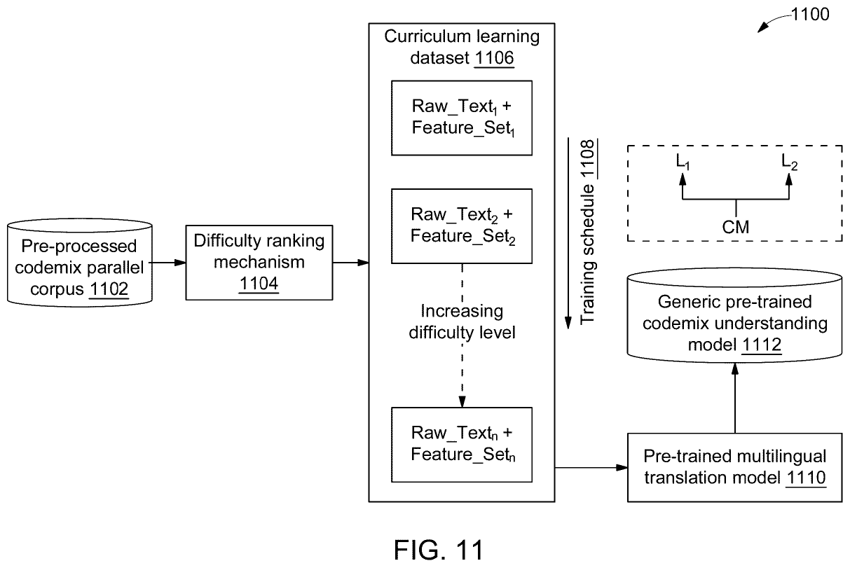

Further, the process 500 may include fine-tuning, by the model fine-tuning engine 320, pre-trained multilingual translation model using the curriculum learning dataset to generate generic pre-trained codemix understanding model, at step 508. The steps 506 and 508 of the process 500 are explained in greater detail in conjunction with FIG. 11.

Referring now to FIG. 11, an exemplary process 1100 for mixed language text understanding for pre-trained multilingual translation models is depicted via a flow chart, in accordance with some embodiments of the present disclosure. FIG. 11 is explained in conjunction with FIGS. 2, 3, 4, 5, 6, 7, 8, 9, and 10.

The data pre-processing engine 306 may generate a pre-processed codemix parallel corpus 1102. The model fine-tuning engine 320 may receive the pre-processed codemix parallel corpus 1102 from the data pre-processing engine 306. Further, the model fine-tuning engine 320 may calculate a complexity metric for each sample of the pre-processed codemix parallel corpus 1102. The complexity metric quantifies a difficulty or a complexity of linguistic samples in the pre-processed codemix parallel corpus 1102.

The complexity metric is a multifaceted algorithm that evaluates the intricacy of codemixed sentences from the pre-processed codemix parallel corpus 1102. The assessment is based on several linguistic and statistical factors. Mathematically, the complexity (θ) of a sample (i) can be expressed as follows:

$${θ}_{complexity}^{i} = {α}_{1} {SP}_{num} ( i ) + {α}_{2} MI ( i ) + {α}_{3} LR ( i )$$

Where α₁, α₂, α₃ are parameters, whose values are extracted statistically from a small random subset of samples from the pre-processed codemix parallel corpus 1102.

The complexity metric is based on various linguistic and statistical factors, such as switching points, mix index, and lexical rarity.

Switching points (SPₙᵤₘ) is a number of language switches within the text. This is obtained using SP_{CM} from the set of linguistic features.

Mix Index (MI) is a degree of mixing in the codemixed text. This is obtained using MI_{CM} from the set of linguistic features.

Lexical Rarity (LR) is a relative frequency of occurrence of codemixed terms in the pre-processed codemix parallel corpus 1102. This is obtained from the number of codemixed terms in the complete pre-processed codemix parallel corpus 1102.

Each codemixed instance in the pre-processed codemix parallel corpus 1102 (training dataset) is scored using the complexity metric. Further, the model fine-tuning engine 320 applies a difficulty ranking mechanism 1104 to the linguistic samples of the pre-processed codemix parallel corpus 1102. Basically, the difficulty ranking mechanism 1104 includes assigning a rank to each of the linguistic samples of the pre-processed codemix parallel corpus 1102 based on the corresponding complexity as determined by the complexity metric. Further, the model fine-tuning engine 320 arranges the linguistic samples of the pre-processed codemix parallel corpus 1102 in an order of increasing complexity to obtain a curriculum learning dataset 1106. Thus, the curriculum learning dataset 1106 includes the linguistic samples ordered from the least to the most complex. Based on the curriculum learning dataset 1106, the model fine-tuning engine 320 creates a training schedule 1108 for fine-tuning a pre-trained multilingual translation model 1110. Thus, it should be noted that the complexity metric is pivotal in curating a structured learning path for the pre-trained multilingual translation model 1110, ensuring a logical progression from less challenging to more intricate codemixed instances.

Further, the model fine-tuning engine 320 fine-tunes the pre-trained multilingual translation model 1110 with the linguistic samples of the curriculum learning dataset 1106 based on the training schedule 1108 to obtain a generic pre-trained codemix understanding model 1112. In this stage, to create the generic pre-trained codemix understanding model 1112, the model fine-tuning engine 320 initiates training process with the pre-trained multilingual translation model 1110 from the data storage 318 being presented with simpler examples that have lower complexity scores. These initial stages focus on helping the pre-trained multilingual translation model 1110 understand basic codemixing patterns and simple linguistic constructs that do not challenge the semantic or syntactic integrity of the text too heavily.

As accuracy and loss metrics of the pre-trained multilingual translation model 1110 indicate readiness, the training regime progresses to more complex examples. The pre-trained multilingual translation model 1110 is then incrementally exposed to samples with higher complexity scores, which introduce more sophisticated codemixing dynamics, irregular grammatical structures, and nuanced semantic contexts.

This gradual increase in difficulty is designed to prevent the pre-trained multilingual translation model 1110 from becoming overwhelmed by the inherent challenges of the codemixed data, thereby reducing the risk of overfitting, and improving generalization. Additionally, the gradual increase in difficulty ensures that the pre-trained multilingual translation model 1110 leverages its understanding of simpler constructs to make sense of more complex ones, promoting a deeper and more holistic understanding of codemixed language.

In an embodiment, architecture of the pre-trained multilingual translation model 1110 is built upon state-of-the-art neural network paradigms, employing transformer-based models. The architecture consists of self-attention mechanisms and encoder-decoder layers, which allow the pre-trained multilingual translation model 1110 to capture long-range dependencies and contextual nuances essential for accurate translation of codemixed text.

The model fine-tuning engine 320 uses the linguistic samples of the pre-processed codemix parallel corpus 1102, ranked in terms of complexity in the curriculum learning dataset 1106, to fine-tune the pre-trained multilingual translation model 1110 to create generic pre-trained codemix understanding model 1112 which is stored in the data storage 322. The pre-trained multilingual translation model 1110 may be a transformer-based model. Owing to the exhaustive size of the pre-processed codemix parallel corpus 1102, the generic pre-trained codemix understanding model 1112 is able to converge well and render state-of-the-art accuracy, overthrowing existing benchmarks by a significant margin.

The pre-trained multilingual translation model 1110 with curriculum learning offers a systematic and pedagogically sound approach to understanding and translating codemixed languages. The generic pre-trained codemix understanding model 1112 so obtained may then be used for understanding codemix texts that include languages L₁ and L₂. By harnessing structured sequencing of training data based on the complexity metric, the pre-trained multilingual translation model 1110 establishes a strong foundation for subsequent domain specific fine-tuning. This methodical training regimen not only enhances performance of the pre-trained multilingual translation model 1110 in codemixed translation but also sets the stage for the creation of highly specialized and accurate domain specific codemix translation models.

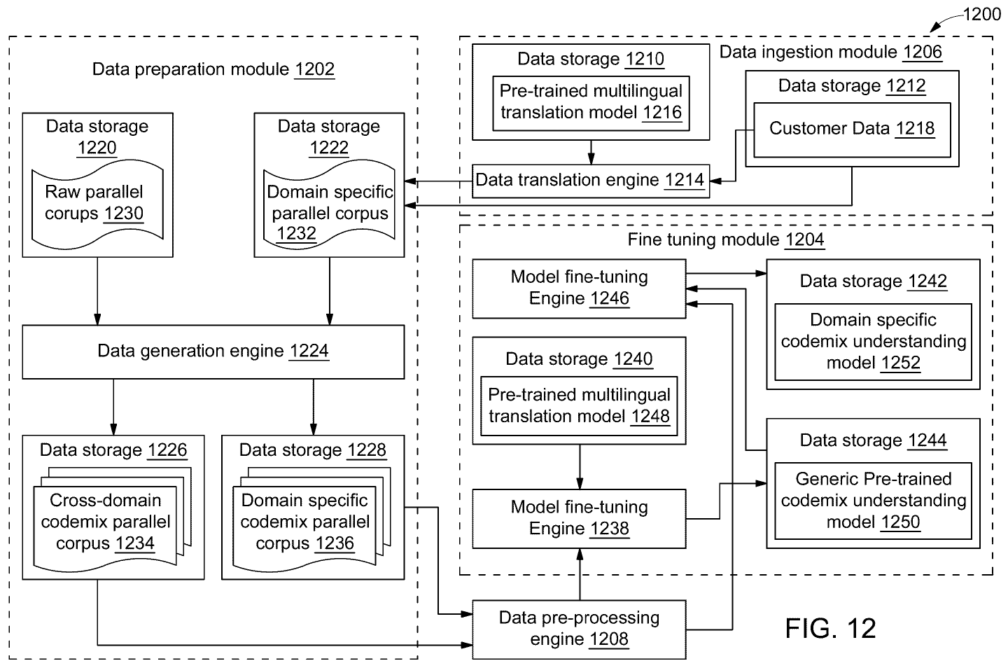

Referring now to FIG. 12, a functional block diagram of an exemplary system 1200 for mixed language text understanding for domain specific GenAI models is illustrated, in accordance with some embodiments of the present disclosure. FIG. 12 is explained in conjunction with FIGS. 2, 3, 4, 5, 6, 7, 8, 9, 10, and 11. The system 1200 may include a data preparation module 1202, a fine-tuning module 1204, a data ingestion module 1206, and a data pre-processing engine 1208.

The data ingestion module 1206 may include a data storage 1210, a data storage 1212, and a data translation engine 1214. The data storage 1210 may store a pre-trained multilingual translation model 1216. The data storage 1212 may store customer data 1218. The customer data 1218 is monolingual domain specific text.

The data translation engine 1214 may receive the pre-trained multilingual translation model 1216 from the data storage 1210. It may be noted that multilingual translation models are AI models that have been pre-trained on text data from multiple languages. The multilingual translation models can understand, process, and generate text in various languages, making them versatile tools for Natural Language Processing (NLP) tasks.

Additionally, the data translation engine 1214 may receive the customer data 1218 from the data storage 1212. Further, the data translation engine 1214 may translate the customer data 1218 into another constituent language of codemix data using the pre-trained multilingual translation model 1216.

The data preparation module 1202 may include a data storage 1220, a data storage 1222, a data generation engine 1224 (analogous to the data generation engine 310), a data storage 1226, and a data storage 1228. The data storage 1220 may include a raw parallel corpus 1230. The raw parallel corpus 1230 may include parallel text in two languages L₁ and L₂ (for example, English and French, English and Spanish, Hindi and English, Spanish and Portuguese, etc.). Further, the data storage 1220 may send the raw parallel corpus 1230 to the data generation engine 1224.

The data storage 1222 may receive the customer data 1218 from the data storage 1212. Additionally, the data storage 1222 may receive translated customer data from the data translation engine 1214. The customer data 1218 and the translated customer create a domain specific parallel corpus 1232 that includes domain specific parallel text in both languages L₁ and L₂. Further, the data storage 1222 may send the domain specific parallel corpus 1232 to the data generation engine 1224.

The data generation engine 1224 may receive the raw parallel corpus 1230 from the data storage 1220. Additionally, the data generation engine 1224 may receive the domain specific parallel corpus 1232 from the data storage 1222. Further, the data generation engine 1224 may generate a cross-domain codemix parallel corpus 1234 (similar to the cross-domain codemix parallel corpus 316) from the raw parallel corpus 1230 and may generate a domain specific codemix parallel corpus 1236 from the domain specific parallel corpus 1232. The cross-domain codemix parallel corpus 1234 and the domain specific codemix parallel corpus 1236 are a fusion of languages L₁ and L₂. Further, the data generation engine 1224 may store the cross-domain codemix parallel corpus 1234 in the data storage 1226 and may store the domain specific codemix parallel corpus 1236 in the data storage 1228.

Further, the data storage 1226 and the data storage 1228 may send the cross-domain codemix parallel corpus 1234 and the domain specific codemix parallel corpus 1236, respectively, to the data pre-processing engine 1208. The data pre-processing engine 1208 may be analogous to the data pre-processing engine 1206. The data pre-processing engine 1208 may transform original formats of the cross-domain codemix parallel corpus 1234 and the domain specific codemix parallel corpus 1236 into pre-processed formats.

The fine-tuning module 1204 may include a first model fine-tuning engine 1238, a data storage 1240, a data storage 1242, a data storage 1244, and a second model fine-tuning engine 1246. The first model fine-tuning engine 1238 may be analogous to the fine-tuning module 304 of the system 300. The data storage 1240 may store a pre-trained multilingual translation model 1248. The pre-trained multilingual translation model 1248 may be a GenAI model pre-trained on text data from multiple languages. The pre-trained multilingual translation model 1248 can understand, process, and generate text in various languages making the pre-trained multilingual translation model 1248 a versatile tool for NLP tasks.

The first model fine-tuning engine 1238 may receive the pre-trained multilingual translation model 1248 from the data storage 1240. Additionally, the first model fine-tuning engine 1238 may receive pre-processed text data corresponding to the cross-domain codemix parallel corpus 1234 from the data pre-processing engine 1208. Further, the first model fine-tuning engine 1238 may fine-tune the pre-trained multilingual translation model 1248 using the pre-processed text data corresponding to the cross-domain codemix parallel corpus 1234, to obtain a generic pre-trained codemix understanding model 1250.

The first model fine-tuning engine 1238 calculates a complexity metric of each of a set of training data (obtained from the cross-domain codemix parallel corpus 1234) based on a curriculum learning framework. Further, the first model fine-tuning engine 1238 ranks each of the set of training data based on the complexity metric. The curriculum learning framework enables the pre-trained multilingual translation model 1248 to gradually learn from simpler to more complex data in the set of training data, thereby enhancing ability of the pre-trained multilingual translation model 1248 to learn intricacies and nuances of various degrees and types of codemixing. The first model fine-tuning engine 1238 may fine-tune the pre-trained multilingual translation model 1248 to obtain a generic pre-trained codemix understanding model 1250.

The generic pre-trained codemix understanding model 1250 is cross-domain. The generic pre-trained codemix understanding model 1250 is trained on a significantly large corpus spanning several domains (i.e., the cross-domain codemix parallel corpus 1234). The generic pre-trained codemix understanding model 1250 is designed to provide a robust foundation for understanding and translating codemixed languages. Upon completion of fine-tuning, the first model fine-tuning engine 1238 may store the generic pre-trained codemix understanding model 1250 in the data storage 1244.

The second model fine-tuning engine 1246 may receive the generic pre-trained codemix understanding model 1250 from the data storage 1244. Additionally, the second model fine-tuning engine 1246 may receive pre-processed text data corresponding to the domain specific codemix parallel corpus 1236 from the data pre-processing engine 1208. Further, the second model fine-tuning engine 1246 may fine-tune the generic pre-trained codemix understanding model 1250 using the pre-processed text data corresponding to the domain specific codemix parallel corpus 1236, to obtain a domain specific codemix understanding model 1252.

The domain specific codemix understanding model 1252 can be used for a multitude of domains, such as, but not limited to, healthcare, finance, e-commerce, etc., leveraging an understanding of the domain as well as codemix-specific content of the domain. The domain specific codemix understanding model 1252 can be used for building real-world applications in domains that require text processing.

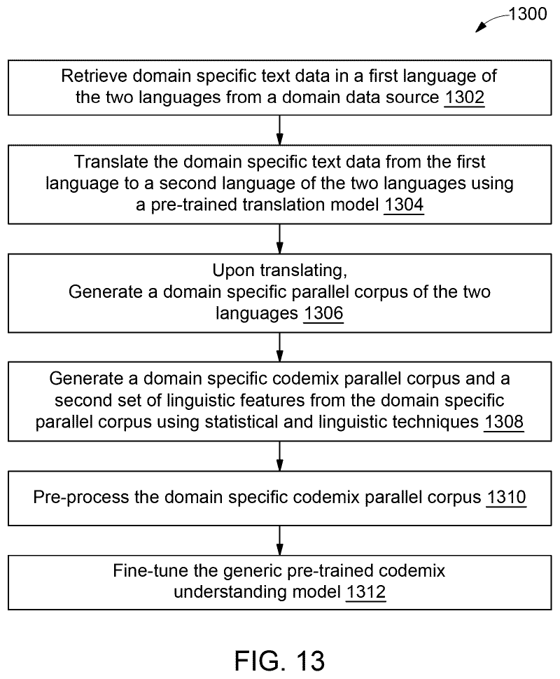

Referring now to FIG. 13 an exemplary process 1300 for mixed language text understanding for domain specific GenAI models is depicted, in accordance with some embodiments of the present disclosure. FIG. 13 is explained in conjunction with FIGS. 2, 3, 4, 5, 6, 7, 8, 9, 10, 11, and 12. The process 1300 may be implemented by the computing device 202 of the system 200. In some embodiments, steps of the process 1300 may be implemented along with steps 402-410 of the process 400. In some alternative embodiments, the steps 402-410 may be implemented prior to execution of the process 1300. In such alternative embodiments, the generic pre-trained codemix understanding model is obtained prior to the initiation of the process 1300. The process 1300 may include retrieving, by the data translation engine 1214, domain specific text data (for example, the customer data 1218) in a first language of the two languages from a domain data source (for example, the data storage 1212), at step 1302.

Further, the process 1300 may include translating, by the data translation engine 1214, the domain specific text data from the first language to a second language of the two languages using a pre-trained translation model (for example, the pre-trained multilingual translation model 1216), at step 1304.

Further, upon translating, the process 1300 may include generating, by the data translation engine 1214, a domain specific parallel corpus (for example, the domain specific parallel corpus 1232) of the two languages, at step 1306.

Further, the process 1300 may include generating, by the data generation engine 1224, a domain specific codemix parallel corpus (for example, the domain specific codemix parallel corpus 1236) and a second set of linguistic features from the domain specific parallel corpus using statistical and linguistic techniques, at step 1308. It may be noted that the second set of linguistic features may include values for Part-of-Speech for each word, word-level language identification, switching point, mixing index, and matrix language.

Further, the process 1300 may include pre-processing, by the data pre-processing engine 1208, the domain specific codemix parallel corpus to obtain a pre-processed domain specific codemix parallel corpus for each language of the two languages, at step 1310. The pre-processed domain specific codemix parallel corpus may include domain specific codemix text data, corresponding domain specific text data in the language, the second set of linguistic features, and translation data of the language corresponding to the domain specific codemix text data. The second set of linguistic features may include values for Part-of-Speech for each word, word-level language identification, switching point, mixing index, and matrix language.

Further, the process 1300 may include fine-tuning, by the second model fine-tuning engine 1246, the generic pre-trained codemix understanding model (such as the generic pre-trained codemix understanding model 1250 or the generic pre-trained codemix understanding model that may be obtained via the process 400) using the pre-processed domain specific codemix parallel corpus to obtain a domain specific codemix understanding model (such as the domain specific codemix understanding model 1252), at step 1312.

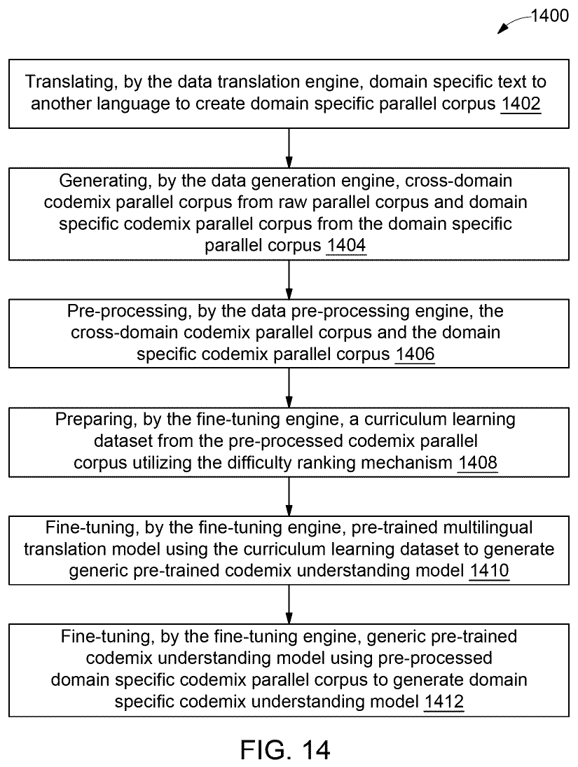

Referring now to FIG. 14, a detailed exemplary process 1400 for mixed language text understanding for domain specific GenAI models is depicted via a flow chart, in accordance with some embodiments of the present disclosure. FIG. 14 is explained in conjunction with FIGS. 2, 3, 4, 5, 6, 7, 8, 9, 10,11, 12, and 13. The process 1400 may be implemented by the computing device 202 of the system 200. The process 1400 may include translating, by the data translation engine 1214, domain specific text to another language to create the domain specific parallel corpus 1232, at step 1402. The customer data 1218 is stored in the data storage 1212. The customer data 1218 is a monolingual (L₁) domain specific customer data. The monolingual customer data 1218 is translated into another language to create the domain specific parallel corpus 1232. In this stage, the customer data 1218 is translated by the data translation engine 1214 from language L₁ to language L₂ using the state-of-the-art pre-trained multilingual translation model 1216 (e.g., mT5, NLLB) obtained from the data storage 1210. The domain specific parallel corpus 1232 is created and stored into the data storage 1222.

Further, the process 1400 may include generating, by the data generation engine 1224, the cross-domain codemix parallel corpus 1234 from the raw parallel corpus 1230 and the domain specific codemix parallel corpus 1236 from the domain specific parallel corpus 1232, at step 1404.

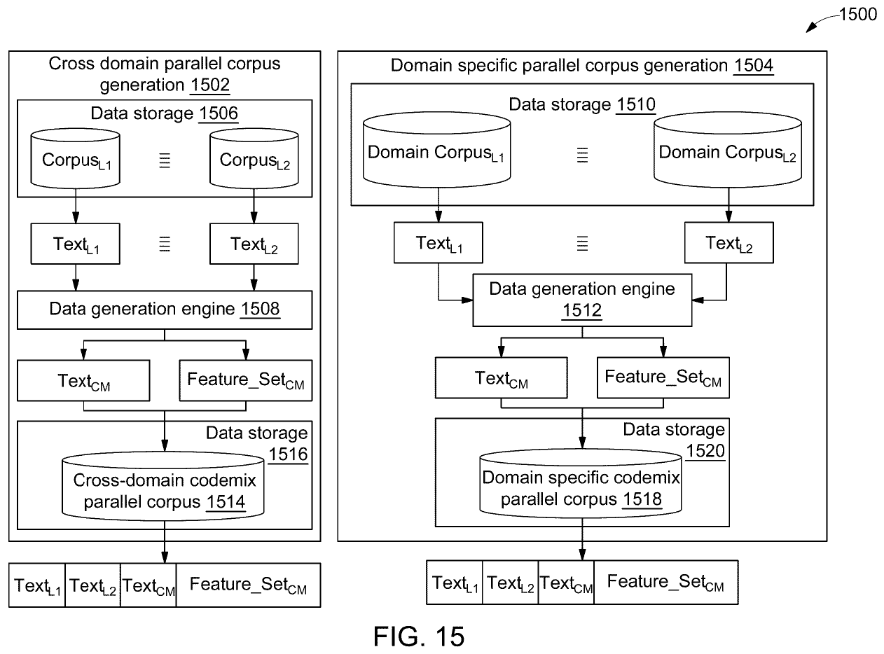

Referring now to FIG. 15, an exemplary control logic 1500 for preparing cross-domain parallel corpus and domain specific parallel corpus of codemix data is depicted via a flow chart, in accordance with some embodiments of the present disclosure. FIG. 15 is explained in conjunction with FIGS. 2, 3, 4, 5, 6, 7, 8, 9, 10, 11, 12, 13, and 14. The control logic 1500 may include cross-domain codemix parallel corpus generation 1502 and domain specific codemix parallel corpus generation 1504. Codemix data may be desired for languages L₁ and L₂.

For the cross-domain corpus, a data storage 1506 may include cross-domain raw parallel corpus including multiple parallel text in both L₁ and L₂ (i.e., Corpus_{L1} and Corpus_{L2}). A data generation engine 1508 may access the cross-domain raw parallel corpus from the data storage 1506.

For the domain specific corpus, a data storage 1510 may include domain specific raw parallel corpus including multiple parallel text in both L₁ and L₂ (i.e., Domain Corpus_{L1} and Domain Corpus_{L2}). The data generation engine 1512 (analogous to the data generation engine 1508) may access the domain specific raw parallel corpus from the data storage 1510.

For both cross-domain and domain specific corpus, each parallel text in L₁ and L₂ (denoted as Text_{L1} and Text_{L2}) is fed to the data generation engine 1508 and the data generation engine 1512, respectively, to produce parallel codemix text (Text_{CM}) in codemix (a fusion of languages L₁ and L₂) and a set of linguistic features (Feature_Set_{CM}). The data generation engine 1508 and the data generation engine 1512 employ mix state-of-the-art statistical and linguistic techniques to generate natural and semantically consistent codemix text (Text_{CM}) as well as linguistic features (Feature_Set_{CM}) from parallel texts Text_{L1} and Text_{L2}.

Further, the data generation engine 1508 combines multiple sets of cross-domain Text_{L1}, Text_{L2}, Text_{CM}, and Feature_Set_{CM} to obtain a cross-domain codemix parallel corpus 1514. The data generation engine 1508 stores the cross-domain codemix parallel corpus 1514 in a data storage 1516.

The data generation engine 1512 combines multiple sets of domain specific Text_{L1}, Text_{L2}, Text_{CM}, and Feature_Set_{CM} to obtain a domain specific codemix parallel corpus 1518. The data generation engine 1512 stores the domain specific codemix parallel corpus 1518 in a data storage 1520.

Referring back to FIG. 14, the process 1400 may include pre-processing, by the data pre-processing engine 1208, the cross-domain codemix parallel corpus 1234 and the domain specific codemix parallel corpus 1236, at step 1406.

The data pre-processing engine 1208 may receive the cross-domain codemix parallel corpus 1514 from the data storage 1516. Additionally, data pre-processing engine 1208 may receive the domain specific codemix parallel corpus 1518 from the data storage 1520. In an original data format, each of the cross-domain codemix parallel corpus 1514 and the domain specific codemix parallel corpus 1518 may include multiple sets of parallel texts in languages L₁ and L₂, (i.e., Text_{L1} and Text_{L2}, respectively), codemix text (Text_{CM}), and a corresponding set of linguistic features (Feature_Set_{CM}). Further, the data pre-processing engine 1208 may transform each of the cross-domain codemix parallel corpus 1514 and the domain specific codemix parallel corpus 1518 from the original data format into a pre-processed data format to obtain a pre-processed cross-domain codemix parallel corpus 1514 and a pre-processed domain specific codemix parallel corpus 1518, respectively. The pre-processed data format is similar to the pre-processed data format 900 and the pre-processed data format 1000. The process of pre-processing has been described in conjunction with FIG. 7.

Further, the process 1400 may include preparing, by the first model fine-tuning engine 1238, a curriculum learning dataset (such as the curriculum learning dataset 1106) from the pre-processed codemix parallel corpus (such as the pre-processed codemix parallel corpus 1102) utilizing a difficulty ranking mechanism (such as the difficulty ranking mechanism 1104), at step 1408. The creation of curriculum learning dataset has been explained in conjunction with FIG. 11.

Further, the process 1400 may include fine-tuning, by the first model fine-tuning engine 1238, the pre-trained multilingual translation model 1248 using the curriculum learning dataset (such as the curriculum learning dataset 1106) to generate the generic pre-trained codemix understanding model 1250, at step 1410. The fine-tuning of the pre-trained multilingual translation model using the curriculum learning dataset has been explained in conjunction with FIG. 11.

Further, the process 1400 may include fine-tuning, by the second model fine-tuning engine 1246, the generic pre-trained codemix understanding model 1250 using the pre-processed domain specific codemix parallel corpus to generate the domain specific codemix understanding model 1252, at step 1412.

The second fine-tuning stage by the second model fine-tuning engine 1246 further hones performance of the generic pre-trained codemix understanding model 1250 by using pre-processed domain specific codemix parallel corpus 1236 to obtain the domain specific codemix understanding model 1252 that is stored in the data storage 1242.

The pre-processed domain specific codemix parallel corpus 1236 introduces customer data (such as the customer data 1218) or highly specialized domain specific data that contain nuanced domain specific terminology, references, jargons, idiomatic languages usages, and contextual implications.

The step 1412 ensures that parameters of the generic pre-trained codemix understanding model 1250 are updated based on the domain specific codemix parallel corpus 1236. This allows the generic pre-trained codemix understanding model 1250 to understand and generate translations that are relevant and specialized to the domain. This ensures that the resultant system is not only domain-aware but also finely attuned to the specific needs and language usage patterns of the end-users.

The process 1400 is a dual fine-tuning process. The step 1412 is an additional stage of refinement, to adjust the generic pre-trained codemix understanding model 1250 to the specificities of a target domain.

The process 1400 provides customization and adaptation. The step 1412 allows for a high degree of customization. For instance, for the healthcare domain, the domain specific codemix understanding model 1252, through the first fine-tuning done (in step 1410) as part of the generic pre-trained codemix understanding model 1250 may understand general medical terminology (along with other domains), while the second fine-tuning of the step 1412 could focus on healthcare specific data, depending on the customer's requirements. This level of adaptation ensures that the final domain specific codemix understanding model 1252 is not only technically proficient but also contextually sensitive to the subtleties of the domain.

The process 1400 provides for evaluation and iteration. After each fine-tuning stage at steps 1410, the domain specific codemix understanding model 1252 undergoes rigorous evaluation using domain specific benchmarks and performance metrics. This includes evaluating ability of the domain specific codemix understanding model 1252 to handle codemixed text that accurately reflects real-world use cases within the domain. Feedback from these evaluations is used to iteratively improve the domain specific codemix understanding model 1252, with adjustments made to the training data or model hyperparameters as necessary.

The process 1400 may allow for integration with the generic pre-trained codemix understanding model 1250, throughout the dual fine-tuning process at step 1412, the strengths of the generic pre-trained codemix understanding model 1250 are preserved and built upon, the domain specific codemix understanding model 1252 retains the comprehensive linguistic knowledge encoded in the generic pre-trained codemix understanding model 1250 while simultaneously adapting to capture the particularities of the domain specific content. this integration ensures that the domain specific codemix understanding model 1252 maintain a high level of general translation quality while excelling in their specialized contexts.

The domain specific codemix understanding model 1252 with dual fine-tuning is a significant advancement in NLP for codemixed language translation. By meticulously refining the generic pre-trained codemix understanding model 1250 through a two-stage fine-tuning process at step 1412, the resulting domain specific codemix understanding model 1252 may achieve unparalleled accuracy and relevance in domain specific applications. The domain specific codemix understanding model 1252 may not only be capable of understanding the complexities of codemixed languages but may also be expertly tailored to meet the exact standards of specialized domains and customer-specific data sets.

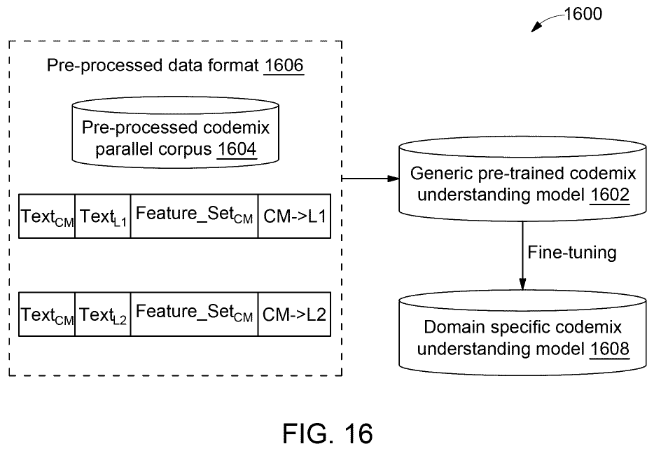

Referring now to FIG. 16, a flow diagram of an exemplary process 1600 for mixed language text understanding for generic pre-trained codemix understanding models is illustrated, in accordance with some embodiments of the present disclosure. FIG. 16 is explained in conjunction with FIGS. 2, 3, 4, 5, 6, 7, 8, 9, 10, 11, 12, 13, 14, and 15. The process 1600 may include receiving, by a generic pre-trained codemix understanding model 1602, a pre-processed codemix parallel corpus 1604 in a pre-processed data format 1606. It may be noted that the generic pre-trained codemix understanding model 1602 may be analogous to the generic pre-trained codemix understanding model 1250. The pre-processed codemix parallel corpus 1604 may include a domain specific codemix parallel corpus (such as the domain specific codemix parallel corpus 1518). Further, the process 1600 may include fine-tuning, by the second model fine-tuning engine 1246, the generic pre-trained codemix understanding model 1602 using the pre-processed codemix parallel corpus 1604 to obtain a domain specific codemix understanding model 1608 (analogous to the domain specific codemix understanding model 1252).

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

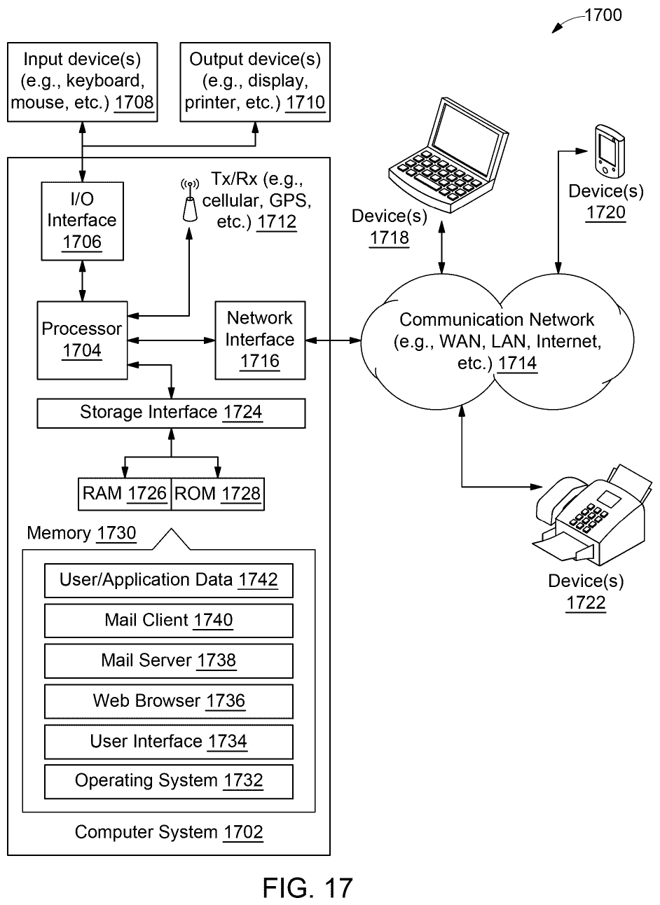

The disclosed methods and systems may be implemented on a conventional or a general-purpose computer system, such as a personal computer (PC) or server computer. Referring now to FIG. 17, a block diagram of an exemplary computer system 1702 for implementing embodiments consistent with the present disclosure is illustrated. Variations of computer system 1702 is used for implementing the computer device 202 for mixed language text understanding for GenAI models. The computer system 1702 may include a central processing unit (“CPU” or “processor”) 1704. The processor 1704 may include at least one data processor for executing program components for executing user-generated or system-generated requests. A user may include a person, a person using a device such as such as those included in this disclosure, or such a device itself. The processor 1704 may include specialized processing units such as integrated system (bus) controllers, memory management control units, floating point units, graphics processing units, digital signal processing units, etc. The processor 1704 may include a microprocessor, such as AMD® ATHLON®, DURON® OR OPTERON®, ARM's application, embedded or secure processors, IBM® POWERPC®, INTEL® CORE® processor, ITANIUM® processor, XEON® processor, CELERON® processor or other line of processors, etc. The processor 1704 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 1704 may be disposed in communication with one or more input/output (I/O) devices via I/O interface 1706. The I/O interface 1706 may employ communication protocols/methods such as, without limitation, audio, analog, digital, monoaural, RCA, stereo, IEEE-1394, near field communication (NFC), FireWire, Camera Link®, GigE, serial bus, universal serial bus (USB), infrared, PS/2, BNC, coaxial, component, composite, digital visual interface (DVI), high-definition multimedia interface (HDMI), radio frequency (RF) antennas, S-Video, video graphics array (VGA), IEEE 802.n/b/g/n/x, Bluetooth, cellular (e.g., code-division multiple access (CDMA), high-speed packet access (HSPA+), global system for mobile communications (GSM), long-term evolution (LTE), WiMAX, or the like), etc.

Using the I/O interface 1706, the computer system 1702 may communicate with one or more I/O devices. For example, the input device 1708 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, altimeter, gyroscope, proximity sensor, or the like), stylus, scanner, storage device, transceiver, video device/source, visors, etc. Output device 1710 may be a printer, fax machine, video display (e.g., cathode ray tube (CRT), liquid crystal display (LCD), light-emitting diode (LED), plasma, or the like), audio speaker, etc. In some embodiments, a transceiver 1712 may be disposed in connection with the processor 1704. The transceiver may facilitate various types of wireless transmission or reception. For example, the transceiver may include an antenna operatively connected to a transceiver chip (e.g., TEXAS INSTRUMENTS® WILINK WL1286®, BROADCOM® BCM4550IUB8®, INFINEON TECHNOLOGIES® X-GOLD 1436-PMB9800® transceiver, or the like), providing IEEE 802.11a/b/g/n, Bluetooth, FM, global positioning system (GPS), 2G/3G HSDPA/HSUPA communications, etc.

In some embodiments, the processor 1704 may be disposed in communication with a communication network 1716 via a network interface 1714. The network interface 1714 may communicate with the communication network 1716. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 1716 may include, without limitation, a direct interconnection, local area network (LAN), wide area network (WAN), wireless network (e.g., using Wireless Application Protocol), the Internet, etc. Using the network interface 1714 and the communication network 1716, the computer system 1702 may communicate with devices 1718, 1720, and 1722. These devices may include, without limitation, personal computer(s), server(s), fax machines, printers, scanners, various mobile devices such as cellular telephones, smartphones (e.g., APPLE IPHONE®, BLACKBERRY® smartphone, ANDROID® based phones, etc.), tablet computers, eBook readers (AMAZON® KINDLER, NOOK® etc.), laptop computers, notebooks, gaming consoles (MICROSOFT® XBOX®, NINTENDO® DS®, SONY® PLAYSTATION®, etc.), or the like. In some embodiments, the computer system 1702 may itself embody one or more of these devices.

In some embodiments, the processor 1704 may be disposed in communication with one or more memory devices 1730 (e.g., RAM 1726, ROM 1728, etc.) via a storage interface 1724. The storage interface may connect to memory devices 1730 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), STD Bus, RS-232, RS-422, RS-485, I2C, SPI, Microwire, 1-Wire, IEEE 1284, Intel® QuickPathInterconnect, InfiniBand, PCIe, etc. The memory drives may further include a drum, magnetic disc drive, magneto-optical drive, optical drive, redundant array of independent discs (RAID), solid-state memory devices, solid-state drives, etc.

The memory devices 1730 may store a collection of program or database components, including, without limitation, an operating system 1732, user interface application 1734, web browser 1736, mail server 1738, mail client 1740, user/application data 1742 (e.g., any data variables or data records discussed in this disclosure), etc. The operating system 1732 may facilitate resource management and operation of the computer system 1702. Examples of operating systems include, without limitation, APPLE® MACINTOSH® OS X, UNIX, Unix-like system distributions (e.g., Berkeley Software Distribution (BSD), FreeBSD, NetBSD, OpenBSD, etc.), Linux distributions (e.g., RED HAT®, UBUNTU®, KUBUNTU®, etc.), IBM® OS/2, MICROSOFT® WINDOWS® (XP®, Vista®/7/8, etc.), APPLE® IOS®, GOOGLE® ANDROID®, BLACKBERRY® OS, or the like. User interface 1734 may facilitate display, execution, interaction, manipulation, or operation of program components through textual or graphical facilities. For example, user interfaces may provide computer interaction interface elements on a display system operatively connected to the computer system 1702, such as cursors, icons, check boxes, menus, scrollers, windows, widgets, etc. Graphical user interfaces (GUIs) may be employed, including, without limitation, APPLE® MACINTOSH® operating systems' AQUA® platform, IBM® OS/2®, MICROSOFT® WINDOWS® (e.g., AERO®, METRO®, etc.), UNIX X-WINDOWS, web interface libraries (e.g., ACTIVEX®, JAVA®, JAVASCRIPT®, AJAX®, HTML, ADOBE® FLASH®, etc.), or the like.

In some embodiments, the computer system 1702 may implement a web browser 1736 stored program component. The web browser may be a hypertext viewing application, such as MICROSOFT® INTERNET EXPLORER®, GOOGLE® CHROME®, MOZILLA® FIREFOX®, APPLE® SAFARI®, etc. Secure web browsing may be provided using HTTPS (secure hypertext transport protocol), secure sockets layer (SSL), Transport Layer Security (TLS), etc. Web browsers may utilize facilities such as AJAX®, DHTML, ADOBE® FLASH®, JAVASCRIPT®, JAVA®, application programming interfaces (APIs), etc. In some embodiments, the computer system 1702 may implement a mail server 1738 stored program component. The mail server may be an Internet mail server such as MICROSOFT® EXCHANGE®, or the like. The mail server may utilize facilities such as ASP, ActiveX, ANSI C++/C #, MICROSOFT.NET® CGI scripts, JAVA®, JAVASCRIPT®, PERL®, PHP®, PYTHON®, WebObjects, etc. The mail server may utilize communication protocols such as internet message access protocol (IMAP), messaging application programming interface (MAPI), MICROSOFT® EXCHANGE®, post office protocol (POP), simple mail transfer protocol (SMTP), or the like. In some embodiments, the computer system 1702 may implement a mail client 1740 stored program component. The mail client may be a mail viewing application, such as APPLE MAIL®, MICROSOFT ENTOURAGE®, MICROSOFT OUTLOOK®, MOZILLA THUNDERBIRD®, etc.

In some embodiments, the memory 1730 may store user/application data 1742, such as the data, variables, records, etc. (e.g., the set of predictive models, the plurality of clusters, set of parameters (batch size, number of epochs, learning rate, momentum, etc.), accuracy scores, competitiveness scores, ranks, associated categories, rewards, threshold scores, threshold time, and so forth) as described in this disclosure. Such databases may be implemented as fault-tolerant, relational, scalable, secure databases such as ORACLE® OR SYBASE®. Alternatively, such databases may be implemented using standardized data structures, such as an array, hash, linked list, struct, structured text file (e.g., XML), table, or as object-oriented databases (e.g., using OBJECTSTORE®, POET®, ZOPE®, etc.). Such databases may be consolidated or distributed, sometimes among the various computer systems discussed above in this disclosure. It is to be understood that the structure and operation of the any computer or database component may be combined, consolidated, or distributed in any working combination.

For example, the memory 1730 may store process-executable instructions, which when executed by the processor 1704, may cause the processor 14 to implement mixed language text understanding for GenAI models. The memory 1730 may include various modules. In an embodiment, the memory 1730 may include the data preparation module 302, the data pre-processing engine 306, and the fine tuning module 304. In such an embodiment, the processor 1704 may be configured to train the pre-trained multilingual translation model 324 for mixed language text understanding to obtain the generic pre-trained codemix understanding model 326. The memory 1730 may also include the data storage 318 and the data storage 322 that may store the pre-trained multilingual translation model 324 and the generic pre-trained codemix understanding model 326, respectively. In an embodiment, the memory 1730 may include the data preparation module 1202, the data ingestion module 1206, the data pre-processing engine 1208, and the fine tuning module 1204. In such an embodiment, the processor 1704 may be configured to further train the generic pre-trained codemix understanding model 1250 for domain specific mixed language text understanding to obtain the domain specific pre-trained codemix understanding model 1252. The memory 1730 may also include the data storage 1244 and the data storage 1242 that may store the generic pre-trained codemix understanding model 1250 and the domain specific pre-trained codemix understanding model 1252, respectively.

Various embodiments provide for method and system for mixed language text understanding for GenAI models. The disclosed method and system have various advantages, some of which are enlisted below.

The method and system provide an improved communication. Codemixing is prevalent in multilingual communities where speakers alternate between languages within the same conversation. A system that can translate codemix text to English, for example, facilitates smoother communication, as an individual may not be fluent in language preferred by other individual.

The method and system provide enhanced accessibility. The method and system provide an increased accessibility to information and resources for individuals who are proficient in English, for example, but encounter codemixed content in their interactions or while browsing online. This is particularly beneficial in diverse linguistic environments where codemixing is common.

The method and system provide for an improved cultural understanding. Codemixing often reflects cultural nuances and linguistic creativity. By translating codemix text to English, for example, the method and system provide insights into the cultural context embedded within the language mixture, fostering greater cultural understanding and appreciation.

The method and system help in efficient language learning. For language learners, especially those studying one of the languages involved in the codemix, the system serves as a valuable learning tool. It offers exposure to authentic codemixed content and provides contextual translations, aiding in language comprehension and acquisition.

The method and system enhance business and marketing opportunities. In regions where codemixing is prevalent, businesses and marketers can leverage the system to understand consumer preferences, sentiment, and trends expressed in codemixed social media posts, customer feedback, and reviews, enabling more targeted strategies.

The method and system help in research and analysis. Researchers in linguistics, sociolinguistics, and computational linguistics can utilize the method and system to analyze codemixing patterns, language dynamics, and sociocultural phenomena present in multilingual communities, leading to advancements in linguistic research.

The method and system aid customer service and support. Companies operating in multilingual environments can deploy the system to support customer service interactions by translating codemixed inquiries, complaints, and feedback into English, for example, facilitating efficient response and resolution.

The method and system help in legal and administrative functions. Government agencies and legal institutions can utilize the system to process codemixed documents, forms, and records more effectively, ensuring accurate interpretation and compliance with regulations.

The method and system provide for integration with AI assistants. Integrating the codemix understanding engine with AI assistants and chatbots enables them to understand and respond to user queries expressed in codemix, enhancing their usability and effectiveness in diverse linguistic contexts.

The method and system provide customization and adaptation. The method and system can be customized and adapted to specific linguistic varieties and domains, allowing for accurate translation and interpretation of codemixed content tailored to the needs of different user groups and applications.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for mixed language text understanding for GenAI models. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for mixed language text understanding for Generative Artificial Intelligence (GenAI) models, the method comprising:
receiving, by a computing device, a raw parallel corpus of two languages, wherein the raw parallel corpus comprises a plurality of samples of cross-domain parallel text data in the two languages;
generating, by the computing device, a cross-domain codemix parallel corpus and a first set of linguistic features from the raw parallel corpus using statistical and linguistic techniques;
determining, by the computing device, a complexity of each of the plurality of samples of the cross-domain codemix parallel corpus based on a set of complexity parameters;
preparing, by the computing device, a curriculum learning dataset from the cross-domain codemix parallel corpus based on the complexity of each of the plurality of samples; and
sequentially fine-tuning, by the computing device, a pre-trained multilingual translation model using each of the plurality of samples in the curriculum learning dataset to obtain a generic pre-trained codemix understanding model.

2. The method of claim 1, further comprising preprocessing, by the computing device, the cross-domain codemix parallel corpus to obtain a pre-processed cross-domain codemix parallel corpus for each language of the two languages, wherein the pre-processed cross-domain codemix parallel corpus comprises cross-domain codemix text data, corresponding cross-domain text data in the language, the first set of linguistic features, and translation data of the language corresponding to the cross-domain codemix text data.

3. The method of claim 1, wherein the set of complexity parameters comprises language switching points, language mix index, and lexical rarity.

4. The method of claim 1, wherein preparing the curriculum learning dataset comprises arranging, by the computing device, the plurality of samples of the cross-domain codemix parallel corpus in an order based on the complexity.

5. The method of claim 1, wherein sequentially fine-tuning the pre-trained multilingual translation model comprises individually fine-tuning, by the computing device, the pre-trained multilingual translation model using each sample of the curriculum learning dataset in an increasing order of complexity.

6. The method of claim 1, further comprising:
retrieving, by the computing device, domain specific text data in a first language of the two languages from a domain data source;
translating, by the computing device, the domain specific text data from the first language to a second language of the two languages using a pre-trained translation model;
upon translating, generating, by the computing device, a domain specific parallel corpus of the two languages; and
generating, by the computing device, a domain specific codemix parallel corpus and a second set of linguistic features from the domain specific parallel corpus using statistical and linguistic techniques.

7. The method of claim 6, further comprising pre-processing, by the computing device, the domain specific codemix parallel corpus to obtain a pre-processed domain specific codemix parallel corpus for each language of the two languages, wherein the pre-processed domain specific codemix parallel corpus comprises domain specific codemix text data, corresponding domain specific text data in the language, the second set of linguistic features, and translation data of the language corresponding to the domain specific codemix text data.

8. The method of claim 7, further comprising fine-tuning, by the computing device, the generic pre-trained codemix understanding model using the pre-processed domain specific codemix parallel corpus to obtain a domain specific codemix understanding model.

9. The method of claim 6, wherein each set of the first set of linguistic features and the second set of linguistic features comprises values for Part-of-Speech for each word, word-level language identification, switching point, mixing index, and matrix language.

10. A computing device for mixed language text understanding for Generative Artificial Intelligence (GenAI) models, the computing device comprising:
a processor; and
a memory communicatively coupled to the processor, wherein the memory stores processor-executable instructions, which when executed by the processor, cause the processor to:
receive a raw parallel corpus of two languages, wherein the raw parallel corpus comprises a plurality of samples of cross-domain parallel text data in the two languages;
generate a cross-domain codemix parallel corpus and a first set of linguistic features from the raw parallel corpus using statistical and linguistic techniques;
determine a complexity of each of the plurality of samples of the cross-domain codemix parallel corpus based on a set of complexity parameters;
prepare a curriculum learning dataset from the cross-domain codemix parallel corpus based on the complexity of each of the plurality of samples; and
sequentially fine-tune a pre-trained multilingual translation model using each of the plurality of samples in the curriculum learning dataset to obtain a generic pre-trained codemix understanding model.

11. The computing device of claim 10, wherein the processor-executable instructions, on execution, further cause the processor to preprocess the cross-domain codemix parallel corpus to obtain a pre-processed cross-domain codemix parallel corpus for each language of the two languages, wherein the pre-processed cross-domain codemix parallel corpus comprises cross-domain codemix text data, corresponding cross-domain text data in the language, the first set of linguistic features, and translation data of the language corresponding to the cross-domain codemix text data.

12. The computing device of claim 10, wherein the set of complexity parameters comprises language switching points, language mix index, and lexical rarity.

13. The computing device of claim 10, wherein to prepare the curriculum learning dataset, the processor-executable instructions, on execution, further cause the processor to arrange the plurality of samples of the cross-domain codemix parallel corpus in an order based on the complexity.

14. The computing device of claim 10, wherein to sequentially fine-tune the pre-trained multilingual translation model, the processor-executable instructions, on execution, further cause the processor to individually fine-tune the pre-trained multilingual translation model using each sample of the curriculum learning dataset in an increasing order of complexity.

15. The computing device of claim 10, wherein the processor-executable instructions, on execution, further cause the processor to:
retrieve domain specific text data in a first language of the two languages from a domain data source;
translate the domain specific text data from the first language to a second language of the two languages using a pre-trained translation model;
upon translating, generate a domain specific parallel corpus of the two languages; and
generate a domain specific codemix parallel corpus and a second set of linguistic features from the domain specific parallel corpus using statistical and linguistic techniques.

16. The computing device of claim 15, wherein the processor-executable instructions, on execution, further cause the processor to pre-process the domain specific codemix parallel corpus to obtain a pre-processed domain specific codemix parallel corpus for each language of the two languages, wherein the pre-processed domain specific codemix parallel corpus comprises domain specific codemix text data, corresponding domain specific text data in the language, the second set of linguistic features, and translation data of the language corresponding to the domain specific codemix text data.

17. The computing device of claim 16, wherein the processor-executable instructions, on execution, further cause the processor to fine-tune the generic pre-trained codemix understanding model using the pre-processed domain specific codemix parallel corpus to obtain a domain specific codemix understanding model.

18. The computing device of claim 15, wherein each set of the first set of linguistic features and the second set of linguistic features comprises values for Part-of-Speech for each word, word-level language identification, switching point, mixing index, and matrix language.

19. A non-transitory computer-readable medium storing computer-executable instructions for mixed language text understanding for Generative Artificial Intelligence (GenAI) models, the computer-executable instructions configured for:
receiving a raw parallel corpus of two languages, wherein the raw parallel corpus comprises a plurality of samples of cross-domain parallel text data in the two languages;
generating a cross-domain codemix parallel corpus and a first set of linguistic features from the raw parallel corpus using statistical and linguistic techniques;
determining a complexity of each of the plurality of samples of the cross-domain codemix parallel corpus based on a set of complexity parameters;
preparing a curriculum learning dataset from the cross-domain codemix parallel corpus based on the complexity of each of the plurality of samples; and
sequentially fine-tuning a pre-trained multilingual translation model using each of the plurality of samples in the curriculum learning dataset to obtain a generic pre-trained codemix understanding model.

20. The non-transitory computer-readable medium of claim 19, wherein the computer-executable instructions are further configured for:
retrieving domain specific text data in a first language of the two languages from a domain data source;
translating the domain specific text data from the first language to a second language of the two languages using a pre-trained translation model;
upon translating, generating a domain specific parallel corpus of the two languages; and
generating a domain specific codemix parallel corpus and a second set of linguistic features from the domain specific parallel corpus using statistical and linguistic techniques.
